(19) United States
(12) Patent Application Publication
(10) Pub. No.: US 2003/0178133 A1
(43) Pub. Date: Sep. 25, 2003

(54) Gas temperature control apparatus for chamber of bonding device

(76) Inventors: Sang Seok Lee, Taegu-kwangyokshi (KR); Sang Ho Park, Pusan-kwangyokshi (KR)

Correspondence Address: MCKENNA LONG & ALDRIDGE LLP, 1900 K STREET, NW, WASHINGTON, DC, 20006, US

(21) Appl. No.: 10/259,640

(22) Filed: Sep. 30, 2002

(30) Foreign Application Priority Data
Mar. 22, 2002 (KR) P 2002-15641

(51) Int. Cl. B32B 31/00

(52) U.S. Cl. 156/285; 156/382

(57) ABSTRACT

A liquid crystal display bonding chamber having a gas temperature control apparatus includes a bonding chamber having first and second stages, a vent pipe coupled to the bonding chamber, the vent pipe introducing air or gas into the bonding chamber after the bonding chamber is under vacuum, and a heater for heating the air or gas introduced through the vent pipe.

This application claims the benefit of Korean Patent Application No. P2002-15641 filed on Mar. 22, 2002, which is hereby incorporated by reference for all purposes as if fully set forth herein.

This application incorporates by reference two co-pending applications, Ser. No. 10/184,096, filed on Jun. 28, 2002, entitled “SYSTEM AND METHOD FOR MANUFACTURING LIQUID CRYSTAL DISPLAY DEVICES” (Attorney Docket Number 8733.666.00) and Ser. No. 10/184,088, filed on Jun. 28, 2002, entitled “SYSTEM FOR FABRICATING LIQUID CRYSTAL DISPLAY AND METHOD OF FABRICATING LIQUID CRYSTAL DISPLAY USING THE SAME” (Attorney Docket Number 8733.684.00), as if fully set forth herein.

### BACKGROUND OF THE INVENTION

### Field of the Invention

In general, recent developments in the information communication field have increased demand for various types of displays devices. In response to this demand, various flat panel type displays such as liquid crystal display (LCD), plasma display panel (PDP), electro-luminescent display (ELD), and vacuum fluorescent display (VFD) have been developed. These are used as displays for various equipments.

In particular, LCD devices have been used because of their high resolution, lightweight, thin profile, and low power consumption. In addition, LCD devices have been implemented in mobile devices such as monitors for notebook computers. Furthermore, LCD devices have been developed for monitors of computer and television to receive and display image signals.

Efforts to improve the image quality of LCD devices contrast with the benefits of high resolution, lightweight, thin profile, and low power consumption. In order to incorporate LCD devices as a general image display, image quality such as fineness, brightness and large display area, for example, must be realized.

LCD devices are provided with an LCD panel for displaying images and a driving unit for applying driving signals to the LCD panel. The LCD panel is provided with first and second glass substrates bonded with a certain cell gap with liquid crystal material injected therebetween.

The process of manufacturing an LCD device in a related art includes forming a sealant pattern on one of the first and second substrates to form an injection inlet, bonding the first and second substrates to each other within a vacuum processing chamber, and injecting liquid crystal material through the injection inlet. In another process of manufacturing an LCD device according to the related art, a liquid crystal dropping method, which is disclosed in Japanese Patent Application No. 11-089612 and 11-172903, includes dropping liquid crystal material on a first substrate, arranging a second substrate over the first substrate, and moving the first and second substrates to be adjacent to each other, and bonding the first and second substrates to each other.

Compared to the liquid crystal injection method, the liquid crystal dropping method is advantageous in that various processes such as, formation of a liquid crystal material injection inlet, injection of the liquid crystal material, and sealing of the injection inlet, are unnecessary since the liquid crystal material is predisposed on the first substrate. To this end, a variety of apparatuses for applying the liquid crystal dropping method have been recently researched.

FIGS. 1 and 2 show cross sectional views of a substrate assembly device using the liquid crystal dropping method according to the related art. In FIG. 1, the substrate assembly device includes a frame 10, an upper stage 21, a lower stage 22, a sealant dispenser (not shown), a liquid crystal material dispenser 30, a processing chamber including an upper chamber unit 31 and a lower chamber unit 32, a chamber moving system 40, and a stage moving system 50. The chamber moving system 40 includes a driving motor driven to selectively move the lower chamber unit 32 to a location where the bonding process is carried out, or to a location where the outflow of the sealant and dropping of the liquid crystal material occur. The stage moving system 50 includes another driving motor driven to selectively move the upper stage 21 along a vertical direction perpendicular to the upper and lower stages 21 and 22.

The sealant dispenser and the liquid crystal material dispenser 30 are installed at a side of the location where the bonding process is carried out. A vacuum valve 23 and a pipeline 24 as a vacuum source for place the upper chamber unit 31 under vacuum are connected to the upper chamber unit 31. A gas purge valve 25 and a gas tube 26 as a pressure source are also connected to the upper chamber unit 31 for returning the upper chamber unit 31 to the atmospheric pressure state.

The chamber moving system 40 includes a driving motor driven to selectively move the lower chamber unit 32 to a location where the bonding process is carried out, or to a location where the outflow of the sealant occurs and dropping of the liquid crystal material occurs. The stage moving system 50 includes another driving motor driven to selectively move the upper stage 21 along a vertical direction perpendicular to the upper and lower stages 21 and 22.

A process of manufacturing a liquid crystal display device using the substrate assembly device of FIGS. 1 and 2 is explained. First, a second substrate 52 is loaded on the upper stage 21, and a first substrate 51 is loaded upon the lower stage 22. Then, the lower chamber unit 32 having the lower stage 22 is moved to a processing location by the chamber moving system 40 for sealant dispensing and liquid crystal material dispensing. Subsequently, the lower chamber unit 32 is moved to a processing location for substrate bonding by the chamber moving system 40. Thereafter, the upper and lower chamber units 31 and 32 are assembled together by the chamber moving system 40 to form a vacuum tight seal, and pressure in the chamber is reduced by a vacuum generating system.

Then, the upper stage 21 is moved downwardly by the stage moving system 50 at the above-mentioned vacuum state so as to closely contact the second substrate 52 fixed to the upper stage 21 to the first substrate 51 fixed to the lower stage 22. Further, the process of bonding the respective substrates to each other is carried out through a continuous pressurization. Then, gas or air is introduced into the chamber part through the gas purge valve 25 and the gas tube 26 to return the vacuum state of the chamber to the atmospheric state, which presses the bonded substrates.

However, the substrate assembly device according to the related art is problematic. First, since the air or gas is supplied in a non-heated state so as to return the vacuum state of the chamber parts to the atmospheric pressure state, the supplied air or moisture contained in the gas may be condensed due to a temperature difference between the vacuum chamber and the vent gas. The condensed air or moisture may be dropped onto the substrate, so that the characteristic of the liquid crystal material may be changed. Secondly, since the vacuum chamber is maintained at the room temperature, spreading of the liquid crystal material between the bonded substrates is slow, which slows the manufacturing process to reduce productivity.

### SUMMARY OF THE INVENTION

Accordingly, the present invention is directed to a gas temperature control apparatus for a chamber of a bonding device that substantially obviates one or more of the problems due to limitations and disadvantages of the related art.

An advantage of the present invention is to provide a gas temperature control apparatus for a bonding chamber of a bonding device, in which manufacturing time is shortened by supplying heated air or gas to the chamber.

Another advantage of the present invention is that the liquid crystal material is smoothly spread on the substrate within a bonding chamber from an increase in the temperature in the chamber.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display bonding chamber having a gas temperature control apparatus comprising a bonding chamber having first and second stages; a vent pipe coupled to the bonding chamber, the vent pipe introducing air or gas into the bonding chamber after the bonding chamber is under vacuum; and a heater for heating the air or gas introduced through the vent pipe.

In another aspect of the present invention, a method of making a liquid crystal display using a bonding chamber comprising inserting first and second substrates of a liquid crystal display into the bonding chamber; placing the bonding chamber under vacuum; bonding the first and second substrates under vacuum in the bonding chamber; and introducing heated air or gas into the bonding chamber after bonding of the first and second substrates.

In another aspect of the present invention, a gas temperature control apparatus for a bonding chamber of a bonding device, the apparatus includes: the bonding chamber for bonding a first substrate and a second substrate; lower and upper stages installed at lower and upper spaces inside the bonding chamber, respectively; a vent pipe for introducing air or gas into the bon ding chamber after the bonding chamber is under vacuum; and a heater for heating the air or gas introduced through the vent pipe. The heater may include a heating coil installed in the vent pipe. The heater may include a heating tank connected to the vent pipe. The heater heats the air or gas to a temperature in the range of 30° C. to 100° C. The vent pipe includes a valve that is opened or closed according to a vent time. The vent time is preferably below 5 minutes. The gas preferably includes N₂.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram illustrating a substrate assembly device based on a liquid crystal dropping type of the related art at the liquid crystal dropping stage;

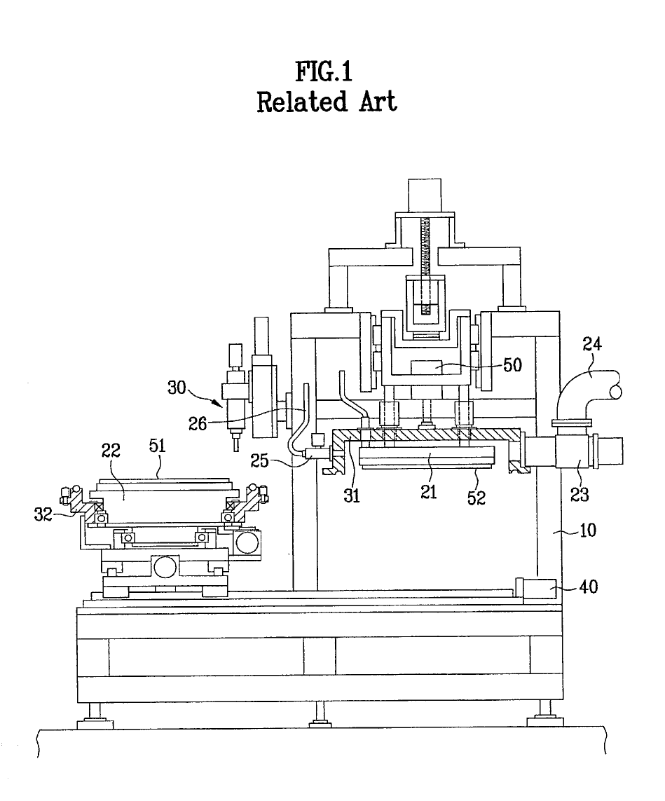

FIG. 2 is a schematic diagram illustrating a substrate assembly device based on a liquid crystal dropping type of the related art at the substrate bonding stage;

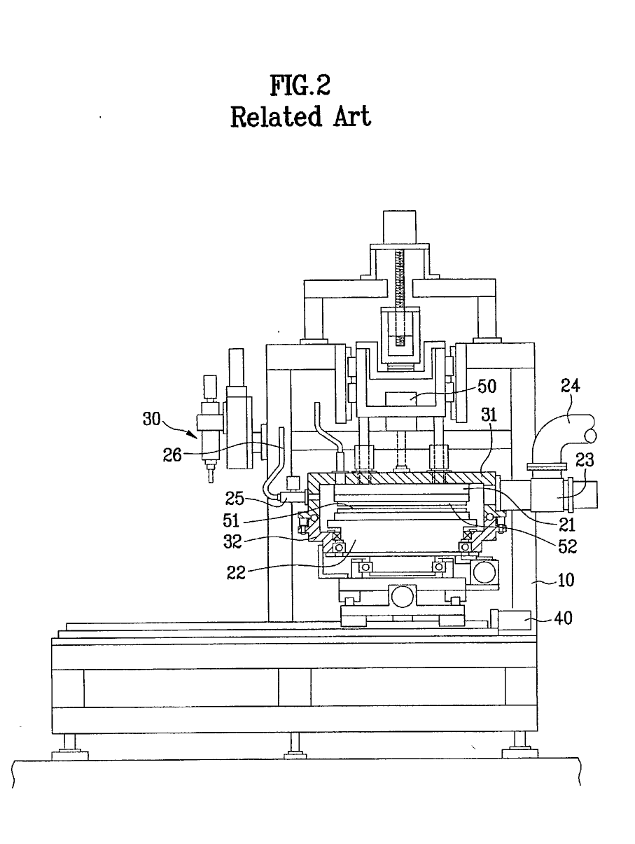

FIG. 3 is a schematic view of a bonding device used in manufacturing an LCD by the liquid crystal dropping method according to the present invention;

FIG. 4 is a schematic view of a gas temperature control apparatus of a bonding chamber according to a first embodiment of the present invention; and

FIG. 5 is a schematic view of a gas temperature control apparatus of a bonding chamber according to a second embodiment of the present invention.

### DETAILED DESCRIPTION OF THE ILLUSTRATED EMBODIMENTS

Reference will now be made in detail to an embodiment of the present invention, example of which is illustrated in the accompanying drawings.

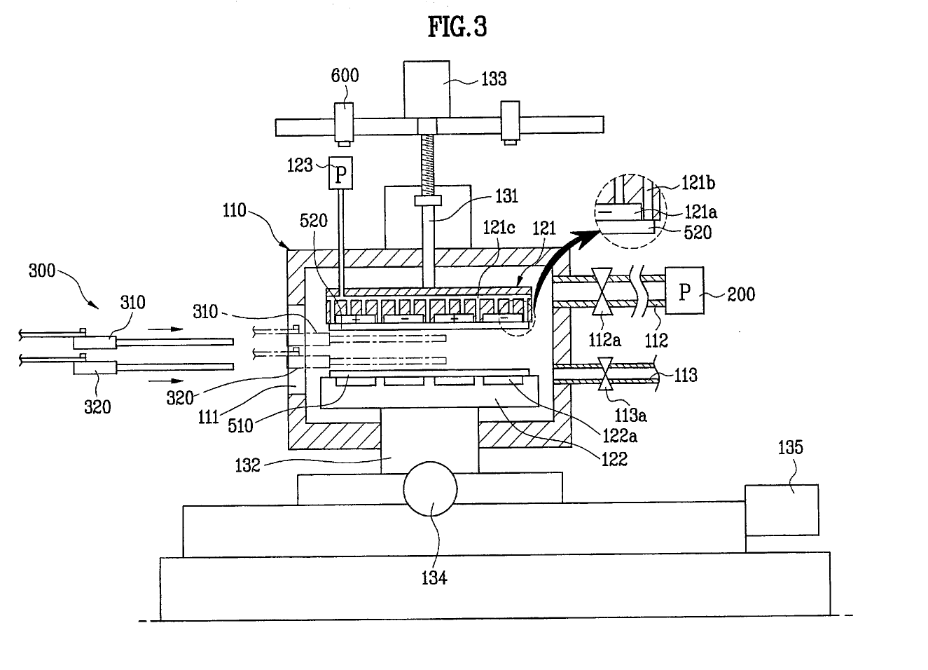

FIG. 3 is a schematic view of a bonding device used in manufacturing an LCD by the liquid crystal applying method according to the present invention. Referring to FIG. 3, a bonding device of the present invention for manufacturing a liquid crystal display device includes a bonding chamber 110, upper stage 121, lower stage 122, stage moving devices 131 and 132, vacuum device including suction pump 200, pipe 112 and valve 112a, venting device including vent pipe or tube 113 and valve 113a, and a loader 300. The bonding chamber 110 selectively becomes a vacuum state or an atmospheric state to bond substrates by pressurizing them and by using a pressure difference in order. An opening 111 is formed at a predetermined part of the circumference of the bonding chamber 110 for receiving or removing each substrate.

An air discharge pipe 112 and a vent pipe 113 are connected to one side of the bonding chamber 110. The air discharge pipe 112 discharges existing air in the bonding chamber by a suction force from a vacuum device. The vent pipe 113 maintains the inside of the bonding chamber at an atmospheric state by having air or gases (N₂) flow into the bonding chamber 110. In this way, the bonding chamber selectively becomes and recovers from the vacuum state. Although only one air discharge pipe 112 and one vent pipe is shown in FIG. 3, a plurality of air discharge pipes 112 and vent pipes may be formed. Valves 112a and 113a electronically controlled for selectively opening and closing the path of the pipes are formed on the air discharge pipe 112 and vent pipe 113, respectively.

At an opening 111 of the bonding chamber 110, a door (not shown) is additionally formed to selectively open or close the opening 111. The door may be a sliding door or a revolving door. Other suitable constructions for the door can be used. When the sliding door or the revolving door is used, a sealant for sealing gaps is preferably provided.

Upper and lower stages facing each other are formed respectively on the upper and lower parts inside the bonding chamber 110. The first and second substrates 510 and 520 brought into the bonding chamber by a loader 300 are fixed to the upper and lower stages 121 and 122 and placed in proper positions in the bonding chamber.

On the upper and lower stages 121 and 122, one or more electric static chucks (ESC) 121a and 122a are provided to fix the substrates using an electrostatic force. Also, one or more vacuum holes 121b are formed on the upper and lower stages to hold and bond the substrates using vacuum force.

The electric static chucks 121a and 122a include a plurality of pairs of flat electrodes, to which direct current power having different polarity is provided for an electrostatic bonding of the substrates. Alternatively, one electric static chuck 121a having both polarities can be used to provide the electrostatic force.

The plurality of vacuum holes 121b are formed along the circumference of each of the electric static chucks 121a provided at the bottom of the upper stage 121. The respective vacuum holes 121b communicate with each other through a plurality of paths 121c. A vacuum force is generated by a vacuum pump 123.

On one side of the lower stage 122, one or more electrostatic chucks 122a are provided to hold the substrates onto the stage by electrostatic force and one or more vacuum holes (not shown) are formed to hold the substrates on the stage by vacuum force.

The stage moving system of the present invention includes an upper moving axis 131, a lower moving axis 132, and driving motors 133 and 134. The moving axis 131 is driven to selectively move the upper stage 121 up and down. The rotating axis 132 is driven to selectively move the lower stage 122 in a lateral direction. The driving motors 133 and 134 for selectively driving the respective axes extend from outside the bonding chamber to the inside of the bonding chamber and coupled to the respective stages 121 and 122.

A driver 135 moves the lower stage 122 laterally when the substrates are being aligned.

The vacuum device delivers a suction force to place the bonding chamber 110 in a vacuum state. For this reason, the vacuum device has a suction pump 200 which is driven to generate an air suction force. The suction pump 200 is formed to communicate with the air discharge pipe 112 of the bonding chamber 110.

The loader is separately provided outside the bonding chamber 110 unlike other components provided inside the bonding chamber 110. The loader loads and unloads the first substrate 510 on which liquid crystal is applied and the second substrate 520 on which a sealant is applied in and out of the bonding chamber 110.

The loader has a first arm 310 for conveying the first substrate 510 with the liquid crystal and a second arm 320 for conveying the second substrate 520 with the sealant. Before the substrates 510 and 520 on the arms 310 and 320 are transferred to the inside of the bonding chamber 110, the first arm 310 is positioned higher than the second arm 320.

The first arm 310 is positioned higher than the second arm 320 to prevent various kinds of foreign particles from being dropped onto the liquid crystal applied on the first substrate 510. In other words, if the second arm 320 is positioned higher than the first arm 310, various kinds of foreign particles may be dropped onto the liquid crystal of the first substrate 510 as the second arm 320 moves.

The first arm 310 does not necessarily transfer only the first substrate 510 with the liquid crystal and the second arm 320 does not necessarily transfer only the second substrate 520 with the sealant. Preferably, however, the first arm 310 conveys only the substrate with the liquid crystal and the second arm 320 conveys only the substrate with the sealant. Alternatively, if one substrate is provided with both the liquid crystal and the sealant, the first arm 310 may convey this substrate and the second arm 320 may convey the other substrate.

The bonding device of the present invention further includes an alignment device 600 for checking the alignment status of the substrates 510 and 520 brought into the bonding chamber 110 to be loaded onto the stages 121 and 122 by the loader. The alignment device 600 may be provided inside or outside the bonding chamber 110. In explaining the alignment device, however, the alignment device 600 is shown to be outside of the bonding chamber 110.

The substrate bonding process using a bonding system of the present invention will be described below.

A first substrate with a liquid crystal and a second substrate with a sealant are provided. The first substrate may be provided with both the liquid crystal and the sealant. As shown in a dotted line in FIG. 3, a loader 300 has the first substrate 510 on a stand-by position at the upper side using a first arm 310. The loader 300 places the second substrate 520 with its surface with the sealant facing down below the first arm 310 using a second arm 320.

When an opening 111 of the bonding chamber 110 is opened, the loader 300 controls the second arm 320 to load the second substrate 520 inside the bonding chamber 110 through the opening 111 with the sealant facing down. An upper stage 121 is placed on the upper side of the second substrate 520. A vacuum pump 123 coupled to the upper stage 121 delivers a vacuum force to vacuum holes 121b formed on the upper stage 121 so that the upper stage 121 holds and fixes the second substrate 520 brought in by the second arm 320. Then, the upper stage 121 with the second substrate 520 ascends.

The loader controls the first arm 310 so that the first substrate 510 with the liquid crystal is loaded into the bonding chamber 110 and onto the lower stage 122. Similarly to the upper stage 121, a vacuum pump (not shown) connected to the lower stage 122 delivers a vacuum force to vacuum holes (not shown) formed on the lower stage 122 to hold and fix the first substrate 510 brought in by the first arm 310. In this way, the first substrate 510 is attached to the lower stage 122.

The second substrate 520 with the sealant is preferably brought in before the first substrate 510 with the liquid crystal. Otherwise, dust which may be generated while the second substrate 520 is being brought in may be undesirably dropped on the liquid crystal of the first substrate 510.

Since the bonded substrates are already provided on the lower stage from completing the bonding process, the second arm 320 unloads the bonded substrates on the lower stage after bringing in the next second substrate for the next bonding process. In this way, the processes of loading and unloading are performed efficiently, thereby reducing the processing time.

When the loading process of the respective substrates 510 and 520 is completed, the arms 310 and 320 of the loader 300 exit the bonding chamber 110. Also, the door of the opening 111 of the bonding chamber 110 closes to seal the bonding chamber 110, as shown in FIG. 3.

Then, although not shown in FIG. 3, a substrate receiver is placed under the upper stage and the second substrate is placed on the substrate receiver from the upper stage. The bonding chamber then becomes a vacuum state. In other words, a suction pump (vacuum device) 200 is driven to generate a suction force which is delivered into the bonding chamber 110 through valve 112a in the air discharge pipe 112. Therefore, the bonding chamber 110 goes under vacuum.

When the bonding chamber 110 is in the vacuum state, the suction pump 200 stops and the valve 112a operates to keep the air discharge pipe 112 closed. Also, the upper and lower stages 121 and 122 activate their respective electro static chucks 121a and 122a to hold and fix the substrates 510 and 520. Then, the substrate receiver, which temporarily held the second substrate 520, is replaced to its original position.

In this state, a stage moving system drives a driving motor 133 to move the upper stage 121 downward to near the lower stage 122. The alignment device 600 checks the alignment status of the substrates 510 and 520 bonded to the respective stages 122 and 121 and also provides a control signal to moving axes 131 and 132 to align the substrates.

The stage moving device moves the second substrate 520 on the upper stage 121 to the first substrate 510 on the lower stage 520 to bond them together by pressing them. In this way, the first bonding process is performed. The first bonding process in which the substrates are bonded by pressing of the stages 121 and 122 does not necessarily complete the bonding process. In this process, the substrates are preferably bonded such that air cannot flow into the space or interval between the substrates when the bonding chamber returns to the atmospheric state.

When the first bonding process is completed, the valve 113a operates to open the vent pipe 113 so that dry air or N₂ gas can flow into the bonding chamber 110. Accordingly, the bonding chamber 110 returns to the atmospheric state and the bonded substrates are pressed together by an atmospheric pressure difference. That is, because the inside of the bonding chamber is at the atmospheric state while the interval between the first and second substrates sealed by the sealant is in the vacuum state, the substrates are pressed to each other by a constant pressure. In this way, the substrates are bonded more completely. After the bonding process, the door at the opening 111 of the bonding chamber 110 is driven to open.

Then, the loader 300 performs the unloading process of the bonded substrates and repeats the above-described processes to bond the next substrates.

During the vent process, the present invention also allows for heating the air or gas up to a predetermined temperature to supply heated air or gas into the bonding chamber. Accordingly, the bonding device according to the present invention further includes a gas temperature control apparatus. The gas temperature control apparatus is capable of preventing, for example, condensation of moisture and variation in the characteristic of liquid crystal material, and enhancing the spreading speed of the applied liquid crystal material.

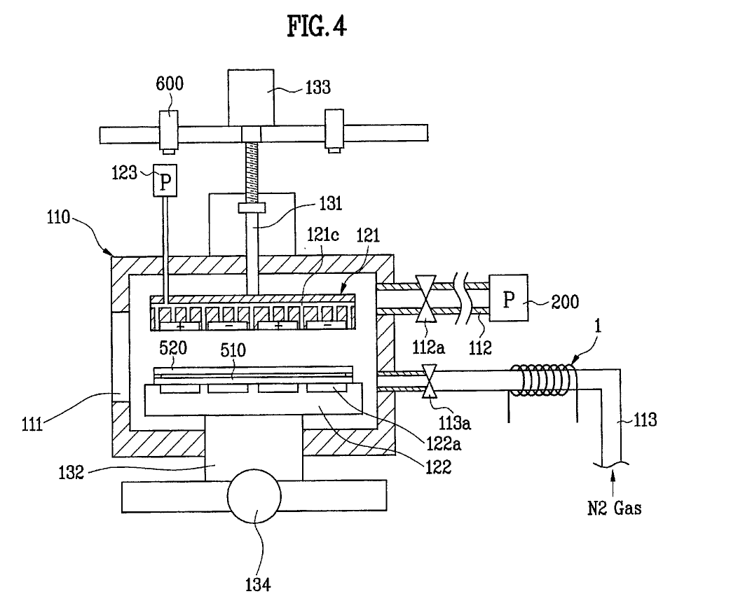

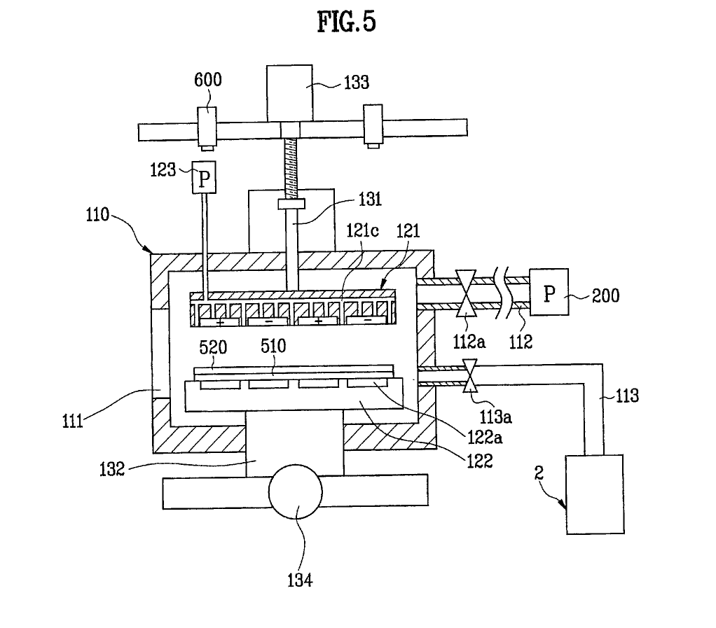

FIG. 4 is a schematic view of a gas temperature control apparatus of a bonding chamber according to a first embodiment of the present invention, and FIG. 5 is a schematic view of a gas temperature control apparatus of a bonding chamber according to a second embodiment of the present invention.

As shown in FIG. 4, a gas temperature control apparatus according to a first embodiment of the invention, includes a heating device, such as a heating coil 1, for example, coupled to the vent pipe 113. FIG. 4 shows the heating coil 1 wrapped around the outer surface of the vent pipe 113. However, the heating coil may also be inside the vent pipe 113. The heating coil 1 heats the gas or air introduced into the bonding chamber through the vent pipe 113 during the vent process.

Although FIG. 4 shows a heating coil as the heating element, other known and suitable heating elements for heating gas or air in the vent pipe may be used.

The air or gas is heated up to a temperature such that the liquid crystal material is not liquefied. For example, the air or gas is heated up to a temperature range of 30° C. to 100° C. The vent time (length of time valve is opened) may be maintained, for example, within five minutes. The heated air or gas introduced into the bonding chamber prevents liquefaction of the liquid crystal material and condensation of moisture contained in the applied liquid crystal material, gas or air. In addition, the heated air or gas elevates the temperature of the interior of the bonding chamber to lower the viscosity of the liquid crystal material, thereby enhancing the spreading speed of the liquid crystal material.

Although a temperature range is provided above, it is also noted that the temperature of the air or gas introduced into the chamber can be the same as or higher than the temperature of the chamber.

As shown in FIG. 5, a gas temperature control apparatus according to a second embodiment of the invention, includes a heating device, such as a heating tank 2 connected to the vent pipe 113. The heating tank 2 heats the air or gas before it enters the vent pipe 113. The temperature conditions for the second embodiment is similar to the first embodiment including the heating coil 1.

In FIG. 3, the vent pipe 113 is shown at the side of the bonding chamber but the location of the vent pipe is not limited to only the side of the bonding chamber. For instance, the vent pipe 113 may be installed at an upper portion or a lower portion of the bonding chamber. Also, a plurality of vent holes and vent pipes may be installed and at the same time a heating device may be installed for every vent pipe or some of the vent pipes.

Accordingly, in the present invention, since air or gas introduced into the bonding chamber during the vent process is heated (but not high enough to liquefy the liquid crystal material), condensation of moisture contained in the gas or air during vacuum can be prevented. Also, since air or gas introduced into the bonding chamber during the vent process is heated (but not high enough to liquefy the liquid crystal material), the temperature of the interior of the bonding chamber is elevated to lower the viscosity of the liquid crystal material, thereby enhancing the spread speed of the liquid crystal material.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display bonding chamber having a gas temperature control apparatus comprising:
a bonding chamber having first and second stages;
a vent pipe coupled to the bonding chamber, the vent pipe introducing air or gas into the bonding chamber after the bonding chamber is under vacuum; and
a heater for heating the air or gas introduced through the vent pipe.

2. The liquid crystal display bonding chamber having a gas temperature control apparatus according to claim 1, wherein the heater comprises a heating coil coupled to the vent pipe.

3. The liquid crystal display bonding chamber having a gas temperature control apparatus according to claim 2, wherein the heating coil is wrapped around the vent pipe.

4. The liquid crystal display bonding chamber having a gas temperature control apparatus according to claim 1, wherein the heating coil is inside the vent pipe.

5. The liquid crystal display bonding chamber having a gas temperature control apparatus according to claim 1, wherein the heater comprises a heating tank coupled to the vent pipe.

6. The liquid crystal display bonding chamber having a gas temperature control apparatus according to claim 1, wherein the heater heats the air or gas to a temperature in the range of about 30° C. to 100° C.

7. The liquid crystal display bonding chamber having a gas temperature control apparatus according to claim 1, wherein the vent pipe comprises a valve that is controlled to open or close according to vent time.

8. The liquid crystal display bonding chamber having a gas temperature control apparatus according to claim 7, wherein the vent time is less than 5 minutes.

9. The liquid crystal display bonding chamber having a gas temperature control apparatus according to claim 1, wherein the gas comprises N₂.

10. A method of making a liquid crystal display using a bonding chamber comprising:
inserting first and second substrates of a liquid crystal display into the bonding chamber;
placing the bonding chamber under vacuum;
bonding the first and second substrates under vacuum in the bonding chamber; and
introducing heated air or gas into the bonding chamber after bonding of the first and second substrates.

11. The method according to claim 10, wherein introducing the heated air or gas includes heating the air or gas as the air or gas travels through a vent pipe coupled to the bonding chamber.

12. The method according to claim 11, wherein the vent pipe is coupled to a heating coil.

13. The method according to claim 12, wherein the heating coil is wrapped around the vent pipe.

14. The method according to claim 12, wherein the heating coil is inside the vent pipe.

15. The method according to claim 11, wherein the air or gas is introduced into the bonding chamber for less than 5 minutes.

16. The method according to claim 10, wherein introducing the heated air or gas includes heating the air or gas before the air or gas enters a vent pipe coupled to the bonding chamber.

17. The method according to claim 16, wherein the air or gas is heated in a heating tank coupled to the vent pipe.

18. The method according to claim 16, wherein the air or gas is introduced into the bonding chamber for less than 5 minutes.

19. The method according to claim 10, wherein the air or gas is heated to a temperature in the range of about 30° C. to 100° C.

20. The method according to claim 1, wherein the gas comprises N₂.
